(19) United States
(12) Patent Application Publication
(10) Pub. No.: US 2021/0256126 A1
(43) Pub. Date: Aug. 19, 2021

(54) PRIVACY-PRESERVING CONTENT CLASSIFICATION

(71) Applicant: Nokia Technologies Oy, Espoo (FI)

(72) Inventor: Zheng YAN, Espoo (FI)

(21) Appl. No.: 17/251,368

(22) PCT Filed: Jun. 15, 2018
(86) PCT No.: PCT/CN2018/091666

§ 371 Date: Dec. 11, 2020

(51) Int. Cl. G06F 21/56; G06F 16/22

(52) U.S. Cl. CPC G06F 21/566; G06F 16/2228; G06F 21/564

(57) ABSTRACT

An apparatus comprising at least one processing core, at least one memory including computer program code, the at least one memory and the computer program code being configured to, with the at least one processing core, cause the apparatus at least to store a malware pattern set and a non-malware pattern set (510), receive two sets of one-way function output values from a device (520), check whether a first one of the two sets of one-way function output values is comprised in the malware pattern set, and whether a second one of the two sets of one-way function output values is comprised in the non-malware pattern set (530), and determine whether the received sets of one-way function output values are more consistent with malware or non-malware based on the checking (540).

### FIELD

The present invention relates to privacy-preserving content classification, such as, for example, detection of malware.

### BACKGROUND

With the development of software, networking, wireless communications, and enhanced sensing capabilities, mobile devices such as smartphones, wearable devices and portable tablets have been widely used in recent decades. A mobile device has become an open software platform that can run various mobile applications, known as apps, developed by not only mobile device manufactures, but also many third parties. Mobile apps, such as social network applications, mobile payment platforms, multimedia games and system toolkits can be installed and executed individually or in parallel in the mobile device.

However, malware has developed quickly at the same time. Malware is, in general, a malicious program targeting user devices, for example mobile user devices. Mobile malware holds similar purposes to computer malware and intends to launch attacks to a mobile device to induce various threats, such as system resource occupation, user behaviour surveillance, and user privacy intrusion.

### SUMMARY OF THE INVENTION

According to some aspects, there is provided the subject-matter of the independent claims. Some embodiments are defined in the dependent claims.

According to a first aspect of the present invention, there is provided an apparatus comprising at least one processing core, at least one memory including computer program code, the at least one memory and the computer program code being configured to, with the at least one processing core, cause the apparatus at least to store a malware pattern set and a non-malware pattern set, receive two sets of one-way function output values from a device, check whether a first one of the two sets of one-way function output values is comprised in the malware pattern set, and whether a second one of the two sets of one-way function output values is comprised in the non-malware pattern set, and determine whether the received sets of one-way function output values are more consistent with malware or non-malware based on the checking.

Various embodiments of the first aspect may comprise at least one clause from the following bulleted list. The previous paragraph is referred to in these clauses as clause 1.
Clause 2. The apparatus according to clause 1, wherein the apparatus is configured to store the malware pattern set in a first Bloom filter and the non-malware pattern set in a second Bloom filter, and wherein the apparatus is configured to check whether the first one of the two sets of one-way function output values is comprised in the malware pattern set by running the first Bloom filter and wherein the apparatus is configured to check whether the second one of the two sets of one-way function output values is comprised in the non-malware pattern set by running the second Bloom filter.
Clause 3. The apparatus according to clause 1 or 2, wherein the malware pattern set is a set of vectors comprising one-way function output values associated with malware and wherein the non-malware pattern set is a set of vectors comprising one-way function output values associated with non-malware.
Clause 4. The apparatus according to any of clauses 1-3, wherein the two sets of one-way function output values are two sets of hash values.
Clause 5. The apparatus according to any of clauses 2-4, wherein running the first one of the two sets of one-way function output values with the first Bloom filter comprises applying a malware weight vector to the first Bloom filter, and wherein running the second one of the two sets of one-way function output values with the second Bloom filter comprises applying a non-malware weight vector to the second Bloom filter.
Clause 6. The apparatus according to any of clauses 1-5, wherein the apparatus is configured to inform the device of the determination whether the received sets of one-way function output values are more consistent with malware or non-malware.
Clause 7. The apparatus according to clause 6, wherein the apparatus is configured to advise the device, what to do with an application associated with the two sets of one-way function output values.
Clause 8. The apparatus according to any of clauses 2-7, wherein the apparatus is configured to define the first Bloom filter and the second Bloom filter based on information received in the apparatus from a central trusted entity.

According to a second aspect of the present invention, there is provided an apparatus comprising at least one processing core, at least one memory including computer program code, the at least one memory and the computer program code being configured to, with the at least one processing core, cause the apparatus at least to store a first set of one-way functions and a second set of one-way functions, the first set of one-way functions comprising a malware function set and the second set of one-way functions comprising a non-malware function set, compile data characterizing functioning of an application running in the apparatus, apply the first set of one-way functions to the data to obtain a first set of one-way function output values and apply the second set of one-way functions to the data to obtain a second set of one-way function output values, and provide the first set of one-way function output values and the second set of one-way function output values to another party.

Various embodiments of the second aspect may comprise at least one clause from the following bulleted list. The previous paragraph is referred to in these clauses as clause 9:
Clause 10. The apparatus according to clause 9, wherein the one-way functions are at least one of modular functions and hash functions
Clause 11. The apparatus according to clause 9 or 10, wherein the data comprises at least one runtime pattern of the application
Clause 12. The apparatus according to clause 11, wherein the at least one runtime pattern of the application comprises at least one pattern of system calls made by the application
Clause 13. The apparatus according to clause 12, wherein the at least one pattern of system calls comprises at least one of: pattern of sequential system calls with differing calling depth that are related to file access, a pattern of sequential system calls with differing calling depth that are related to network access and a pattern of sequential system calls with differing calling depth that are related to other operations than network access and file access
Clause 14. The apparatus according to any of clauses 9-13, further configured to delete or quarantine the application based on an indication received from the server in response to the sets of one-way function output values
Clause 15. The apparatus according to any of clauses 9-14, wherein the apparatus is a mobile device.

According to a third aspect of the present invention, there is provided a method comprising storing a malware pattern set and a non-malware pattern set, receiving two sets of one-way function output values from a device, checking whether a first one of the two sets of one-way function output values is comprised in the malware pattern set, and whether a second one of the two sets of one-way function output values is comprised in the non-malware pattern set, and determining whether the received sets of one-way function output values are more consistent with malware or non-malware based on the checking.

Various embodiments of the third aspect may comprise at least one clause corresponding to a clause from the preceding bulleted list laid out in connection with the first aspect.

According to a fourth aspect of the present invention, there is provided a method, comprising storing, in an apparatus, a first set of one-way functions and a second set of one-way functions, the first set of one-way functions comprising a malware function set and the second set of one-way functions comprising a non-malware function set, compiling data characterizing functioning of an application running in the apparatus, applying the first set of one-way functions to the data to obtain a first set of one-way function output values and applying the second set of one-way functions to the data to obtain a second set of one-way function output values, and providing the first set of one-way function output values and the second set of one-way function output values to another party.

Various embodiments of the fourth aspect may comprise at least one clause corresponding to a clause from the preceding bulleted list laid out in connection with the second aspect.

According to a fifth aspect of the present invention, there is provided an apparatus comprising means for storing a malware pattern set and a non-malware pattern set, means for receiving two sets of one-way function output values from a device, means for checking whether a first one of the two sets of one-way function output values is comprised in the malware pattern set, and whether a second one of the two sets of one-way function output values is comprised in the non-malware pattern set, and means for determining whether the received sets of one-way function output values are more consistent with malware or non-malware based on the checking.

According to a sixth aspect of the present invention, there is provided an apparatus comprising means for storing a first set of one-way functions and a second set of one-way functions, the first set of one-way functions comprising a malware function set and the second set of one-way functions comprising a non-malware function set, means for compiling data characterizing functioning of an application running in the apparatus, means for applying the first set of one-way functions to the data to obtain a first set of one-way function output values and applying the second set of one-way functions to the data to obtain a second set of one-way function output values, and means for providing the first set of one-way function output values and the second set of one-way function output values to another party.

According to a seventh aspect of the present invention, there is provided a non-transitory computer readable medium having stored thereon a set of computer readable instructions that, when executed by at least one processor, cause an apparatus to at least store a malware pattern set and a non-malware pattern set, receive two sets of one-way function output values from a device, check whether a first one of the two sets of one-way function output values is comprised in the malware pattern set, and whether a second one of the two sets of one-way function output values is comprised in the non-malware pattern set, and determine whether the received sets of one-way function output values are more consistent with malware or non-malware based on the checking.

According to an eighth aspect of the present invention, there is provided a non-transitory computer readable medium having stored thereon a set of computer readable instructions that, when executed by at least one processor, cause an apparatus to at least store a first set of one-way functions and a second set of one-way functions, the first set of one-way functions comprising a malware function set and the second set of one-way functions comprising a non-malware function set, compile data characterizing functioning of an application running in the apparatus, apply the first set of one-way functions to the data to obtain a first set of one-way function output values and applying the second set of one-way functions to the data to obtain a second set of one-way function output values, and provide the first set of one-way function output values and the second set of one-way function output values to another party.

### BRIEF DESCRIPTION OF THE DRAWINGS

FIG. 1 illustrates an example system in accordance with at least some embodiments of the present invention;

FIG. 2 illustrates an example system in accordance with at least some embodiments of the present invention;

FIG. 3 illustrates an example apparatus capable of supporting at least some embodiments of the present invention;

FIG. 4 illustrates signalling in accordance with at least some embodiments of the present invention;

FIG. 5 is a flow graph of a method in accordance with at least some embodiments of the present invention, and

FIG. 6 is a flow graph of a method in accordance with at least some embodiments of the present invention.

### EMBODIMENTS

### Definitions

In the present disclosure, the expression “hash function” is used to denote a one-way function. However, while hash functions are often used, they are not the only one-way functions which are usable with embodiments of the present invention. To the contrary, it is to be understood that, for example, elliptic curves, the Rabin function and discrete exponentials may be used in addition to, or alternatively to, hash functions even if the expression “hash function” is used in this disclosure. An example class of hash functions usable with at least some embodiments of the invention is cryptographic hash functions.
Malware is software that behaves in an unauthorized way, for example such that it is contrary to the interests of the user, for example by stealing the user's information or running software on the user's device without the user's knowledge. An application may be classified as malware by an authorized party, for example.
Non-malware is software that is not malware.
In a Bloom filter, a hash function may be a modular function

Privacy of a user may be protected in server-based malware detection by using plural hash functions, to obtain hash values of behavioural patterns of applications. The hash values may be provided to a server, which may check if the hash values match existing hash value patterns associated with malware behaviour. Since only hashes are provided to the server, the server does not gain knowledge of what the user has been doing. The server may obtain the hash value patterns associated with malware behaviour from a central trusted entity, which may comprise an antivirus software company, operating system vendor or governmental authority, for example.

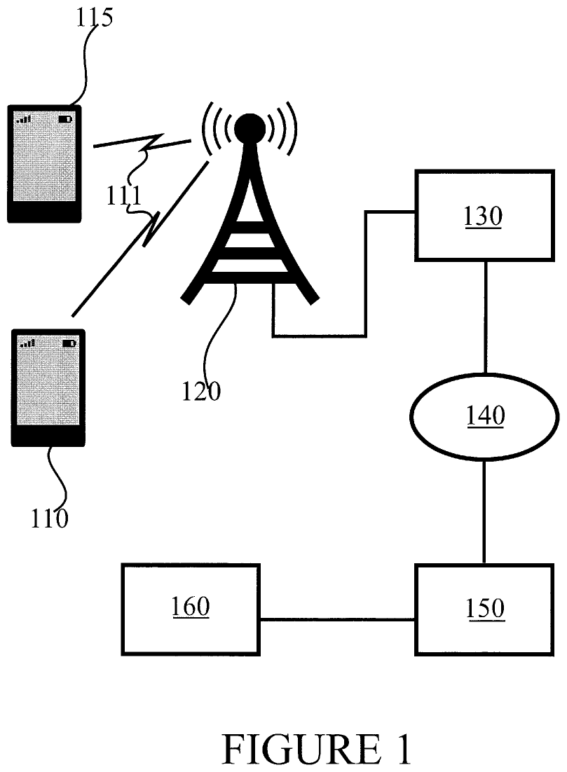

FIG. 1 illustrates an example system in accordance with at least some embodiments of the present invention. Mobiles 110 and 115 may comprise, for example, smartphones, tablet computers, laptop computers, desktop computers, wrist devices, smart jewelry or other suitable electronic devices. Mobile 110 and mobile 115 need not be of a same type, and the number of mobiles is not limited to two, rather, two are illustrated in FIG. 1 for the sake of clarity.

The mobiles are in wireless communication with base station 120, via wireless links 111. Wireless links 111 may comprise uplinks for conveying data from the mobile toward the base station direction, and downlinks for conveying information from the base station toward the mobiles. Communication over wireless links may take place using a suitable wireless communication technology, such as a cellular or non-cellular technology. Examples of cellular technologies include long term evolution, LTE, and global system for mobile communication, GSM. Examples of non-cellular technologies include wireless local area network, WLAN, and worldwide interoperability for microwave access, WiMAX, for example. In case of non-cellular technologies, base station 120 might be referred to as an access point, however the expression base station is used herein for the sake of simplicity and consistency.

Base station 120 is in communication with network node 130, which may comprise, for example, a base station controller or a core network node. Network node 130 may be interfaced, directly or indirectly, to network 140 and, via network 140, to server 150. Server 150 may comprise a cloud server or computing server in a server farm, for example. Server 150 is, in turn, interfaced with central trusted entity 160. Server 150 may be configured to perform offloaded malware detection concerning applications running in mobiles 110 and 115. Central trusted entity 160 may comprise an authorized party, AP, which may provide malware-associated indications to server 150.

Although discussed herein in a mobile context, the disclosure extends also to embodiments where devices 110 and 115 are interfaced with server 150 via wire-line communication links. In such cases, the devices may be considered, generally, user devices.

Devices such as mobiles 110 and 120 may be infected with malware. Attackers may intrude a mobile device via air interfaces, for example. Mobile malware could make use of mobile devices to send premium SMS messages to incur costs to the user and/or to subscribe to paid mobile services without informing the user. In recent years, mobile devices enhanced with sensing and networking capabilities have been faced with novel threats, which may seek super privileges to manipulate user information, for example by obtaining access to accelerometers and gyroscopes, and/or leaking user private information to remote parties. Nowadays, malware can rely on camouflage techniques to produce metamorphoses and heteromorphic versions of itself, to evade detection by anti-malware programs. Malware also uses other evasion techniques to circumvent regular detection. Some malware can broadcast itself using social networks based on social engineering attacks, by making use of the curiosity and credulity of mobile users. With smart wearable devices and other devices emerging, there will be more security threats targeting mobile devices.

In general, malware may be detected using static and dynamic methods. The static method aims to find malicious characteristics or suspicious code segments without executing applications, while the dynamic approach focuses on collecting an application's behavioural information and behavioural characteristics during its runtime. Static methods cannot be used to detect new malware, which has not been identified to the device in advance. On the other hand, dynamic methods may consume a lot of system resources. While offloading dynamic malware detection to another computational substrate, such as a server, such as a cloud computing server, saves computational resources in the device itself, it discloses information concerning applications running in the device to the computational substrate which performs the computation, which forms a privacy threat.

One way to detect malware in a hybrid and generic way, especially for mobile malware in Android devices, comprises collecting execution data of a set of known malware and non-malware applications. Thus it is possible to generate, for the known malware and non-malware applications, patterns of individual system calls and/or sequential system calls with different calling depth that are related to file and network access, for example. By comparing the patterns of the individual and/or sequential system calls of malware and non-malware applications with each other, a malicious pattern set and a normal pattern may be constructed that may be used for malware and non-malware detection.

Applied to classifying an unknown application, a dynamic method may be used to collect its runtime system calling data in terms of individual calls and/or sequential system calls, such as, for example sequential system calls with different depth. Frequencies of system calls may also be included in such data which characterizes the functioning of an application. The calls may involve file and/or network access, for example. Target patterns, such as the system call patterns, of the unknown application may be extracted from its runtime system calling data. By comparing them with both the malicious pattern set and the normal pattern set, the unknown application may be classified as malware or non-malware based on its dynamic behavioural pattern. At least some embodiments of the present invention rely on such logic to classify applications.

The malicious pattern set and the normal pattern set can be further optimized and extended based on patterns of newly confirmed malware and non-malware applications. Since data collected for malware detection contains sensitive information about mobile usage behaviors and user activities, it may intrude user privacy to share it with a third party.

To enable comparing behaviour of an unknown application with the malicious pattern set and the normal pattern set, hash functions may be employed. In detail, data characterizing functioning of the application may be collected, for example using a standardized manner to gather, for example, the system call data described above. Once the data has been collected, two sets of hash functions may be applied to the data. A set of hash functions may comprise, for example, hash functions of a same hash function family but with differing parameters, such that different hash functions of the set each produce different hash output values with a same input. The data characterizing functioning of the application thus characterizes the behaviour of the application when it is run, and not the static software code of the application as stored.

A first set of hash functions may be associated with malware, and/or a second set of hash functions may be associated with non-malware. Consequently, running the first set of hash functions with the data produces a first set of hash output values and/or running the second set of hash functions on the data produces a second set of hash output values. The first set of hash output values may be associated with malware and the second set of hash output values may be associated with non-malware. These are, respectively, a malware pattern and a non-malware pattern. The malware-associated hash functions may be associated with malware merely due to being used with malware, in other words, the hash functions themselves do not have malware aspects.

A server may store sets of hash output values which are associated with malware and/or with non-malware. The hash output values associated with malware, known as a malware pattern set, may have been obtained from observing behaviour of known malware, by hashing data which characterizes the functioning of the known malware with the set of hash functions associated with malware. The hash output values associated with non-malware, that is, a non-malware pattern set, may likewise be obtained using known non-malware. Thus where a device sends its hash output value sets obtained from the data to such a server, the server may compare the hash output values received from the device to the hash output values it has, to determine if the behaviour of the application in the device matches with known malware and/or non-malware. In other words, the server may determine whether the hash output values received from the device are a malware pattern or a non-malware pattern.

Acting thus using hashes, the technical effect and benefit is obtained wherein behaviour-based malware detection may be performed offloaded partly into a server, such as a cloud server, such that the server does not gain knowledge of what the user does with his device. In other words, the solution provides behaviour-based malware detection which respects user privacy. An authorized party, AP, may collect data characterizing the functioning of a set of known malware and non-malware to generate the malware pattern set and the non-malware pattern set used for malware detection. Where Bloom filters are used, their use saves memory in the server owing to recent advances in implementing Bloom filters.

One approach to malware detection in a privacy-preserving way uses Bloom filters, which may optionally use counting. For each malware pattern, the AP may use a malware Bloom filter, MBF, for a set of malware-associated hash functions Hm to calculate its hash output values and send them to a third party, such as a server. The server may insert these hash output values into the right positions of Bloom filter MBF with counting and correspondingly, optionally, save a weight of the pattern into a table named MalWeight. The malware Bloom filter MBF may thus be constructed using the malware hash output values, the weights of which may further be recorded in MalWeight. Similarly, for a non-malware application pattern, AP may use another Bloom filter for non-malware apps, NBF, with hash functions Hn to calculate hash output values and sends them to the server. The server may insert these hash output values into the right positions of Bloom filter NBF, and correspondingly save the weight of the patterns into a table named NorWeight. In this way, the server may insert all non-malware hash value output patterns into NBF to finish the construction of NBF and, optionally, record their weights in NorWeight.

When detecting an unknown application in a user device, its data characterizing its runtime behaviour may be collected, such as system calling data including individual calls and/or sequential system calls with different depth. Then the user device may use hash function sets Hm and Hn on the collected runtime data to calculate the corresponding hash output values and send them to the server for checking if the hash output value patterns match the patterns inside MBF and NBF. Based on the hash output value matching, corresponding weights may be added together in terms of non-malware patterns and malware patterns, respectively. Based on the summed weights and predefined thresholds, the server can judge if the tested app is malware or a non-malware app.

When new malware and/or non-malware apps are collected by the AP, the AP may make use them to regenerate malware pattern sets and non-malware pattern sets. If there are new patterns to be added into MBF and/or NBF, the AP may send their hash output value sets to the server, which may insert them into the MBF and/or the NBF by increasing corresponding counts in the Bloom filter, for example, and at the same time updating MalWeight and/or NorWeight. If there are some patterns' weights which need to be updated, the AP may send their hash output values to the server, which may check their positions in MBF and/or NBF and update MalWeight and/or NorWeight accordingly.

If there are some patterns needed to be removed from MBF or NBF, the AP may send their hash output values to the server, which removes them from MBF and/or NBF by deducting corresponding counts in the Bloom filter and at the same time updating MalWeight and/or NorWeight. In case that any one Bloom filter's length is not sufficient for the purpose of malware detection due to the increase of pattern number, a new Bloom filter may be re-constructed with new filter parameters and hash function sets.

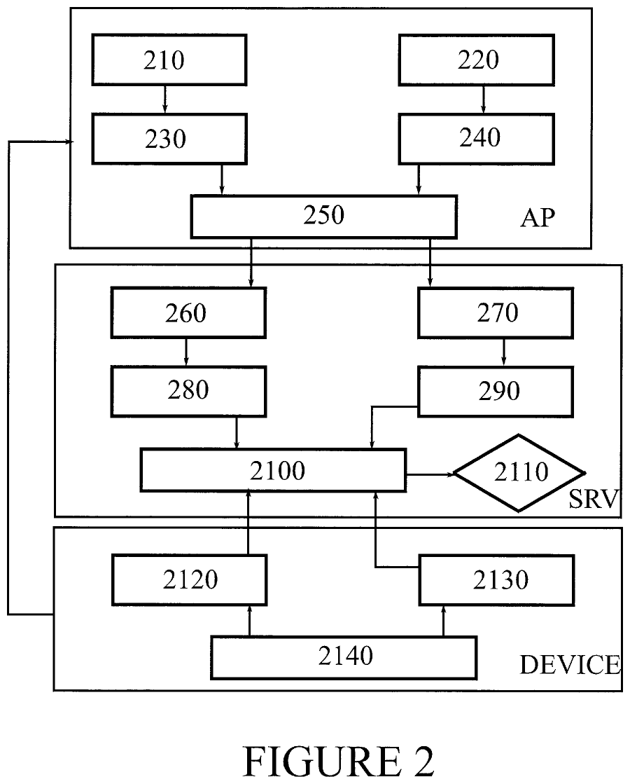

FIG. 2 illustrates an example system in accordance with at least some embodiments of the present invention. The authorized party AP is at the top of the figure and some of its functions are illustrated therein. In phases 210 and 220, malware and non-malware samples are collected, respectively, that is, applications are collected which are, and are not, known malware. Such application samples may be provided by operators or law enforcement, for example. In phases 230 and 240, respectively, data characterizing the functioning of the malware and non-malware samples is collected, as described above. The known malware may be run in a simulator or virtual machine, for example, to prevent its spread. In phase 250, malware and non-malware hash value patterns are generated by applying the set of malware hash functions and the set of non-malware hash functions to the data collected in phases 230 and 240.

In the server, SRV, malware hash value patterns are received into Bloom filter MBF in phase 260 and non-malware hash value patterns are received into Bloom filter NBF in phase 270. MBF weights are generated/adjusted in phase 280, and NBF weights are generated/adjusted in phase 290. In phase 2100 hash value patterns from a user device are compared to hash value patterns received in the server from AP, to determine whether the hash value patterns received from the user device more resemble malware or non-malware patterns received from the AP, weighted by the corresponding weights. A decision phase 2110 is invoked when a threshold is crossed in terms of detection reliability. The threshold may relate to operation of the Bloom filters as well as to the weights.

In the device, phase 2140 comprises executing applications, optionally in a virtual machine instance, and collecting the data which characterizes the functioning of the applications. In phases 2120 and 2130, respectively, the malware hash function set and the non-malware hash function set are used to obtain a malware hash value pattern and a non-malware hash value pattern. These are provided to the server SRV for comparison in phase 2100.

A separate feedback is provided from the user device, which may comprise a mobile device such as mobile 110 in FIG. 1, for example. The feedback may be used to provide application samples to the AP, for example. The sets of hash functions Hm and Hn may be agreed beforehand and shared between participating entities such as AP, the server and the user device.

A security model is now described. Driven by personal profits and considering individual reputation, each type of party involved does not collude with other parties. It is assumed that the communications among the parties is secure by applying appropriate security protocols. The AP and the server cannot be fully trusted. They may operate according to designed protocols and algorithms, but they may be curious concerning device user privacy or other parties' data. Mobile device users worry about individual usage information or other personal information disclosure to AP and/or the server. In the disclosed method, the device pre-processes locally collected application execution data and it extracts application behavioral patterns. Through hashing the extracted data patterns with the hashes used by Bloom filters, it hides real plain information of extracted patterns when sending them to the server for malware detection.

When AP generates two pattern sets by collecting known malware and normal apps, devices may merely send app installation packages to it, thus no any device user information is necessarily disclosed to the AP. During malware detection and pattern generation, the server cannot obtain any device user information since it can only gets hash output values, it cannot know and plain behavioral data or the app names either.

In the proposed method, a great deal of data searching and matching needs to be done. A Bloom filter, BF, is a space-efficient probabilistic data structure, conceived by Burton Howard Bloom in 1970. It is used to test whether an element is a member of a set. False positive matches are possible, but false negatives are not—in other words, a query returns either “possibly in set” or “definitely not in set”. Elements can be added to the set, element removing is also possible, which can be addressed with a “counting” filter. The more elements that are added to the set, the larger the probability of false positives.

Suppose set K has n elements K={k₁, k₂, . . . , kₙ}, K is mapped into a bit array V with length l to store through a number of h hash functions H={h₁, h₂, . . . , hₕ}, where hᵢ (i=1, . . . , h) are independent with each other. For generating a Bloom filter, we need to decide H and l, and the decision depends on the size of K, i.e., n. BF construction is the process of inserting the elements in K, which contains the following steps:

Step 1: BF initialization by setting all bits in V as 0;

Step 2: For any kᵢ (i=1, . . . , n), get a number of h hash codes h₁(kᵢ), h₂(kᵢ), hₕ(kᵢ) in order to decide the positions where kᵢ is mapped into V. We mark the corresponding positions as BF[h₁(kᵢ)], BF[h₂(kᵢ)], . . . , BF[hₕ(kᵢ)].

Step 3: Make the value of V in the mapped positions BF[h₁(kᵢ)], BF[h₂(kᵢ)], . . . , BF[hₕ(kᵢ)] as 1. Thus, V represents a Bloom filter of set K.

For querying if element x is inside K, one direct method is to compare x with each element in K in order to get the result, the accuracy of query is 100%. Another method is to use a Bloom filter, BF. First, we calculate the h hash codes of x, decides x's mapped positions in V, i.e., BF[h₁(x)], BF[h₂(x)], BF[hₕ(x)]. Then we check if all above mapped positions' values are 1. If there is one bit is 0, it means x is definitely not inside K. If all above mapped positions' values are 1, this means x could be inside K. Although BF based search or query could cause false positive, it can bring advantages regarding storage space and search time. This is very useful and beneficial for big data process. For reducing false positive, a suitable BF may be designed by selecting proper system parameters. With this way, we can reduce error detection to minimum and increase detection accuracy as high as possible.

The original Bloom filter can only support inserting new elements into the filter vector and searching. A countable Bloom filter supports reversibly searching and deleting elements from the vector. Due to the advanced features of Bloom filter in terms of storage space saving and fast search in the context of big data, it can be widely used in many fields. However, the Bloom filter that can support digital number operations should be further studied in order to satisfy the demands of new applications.

TABLE 1
Notations

| | |
|---|---|
| MS | The malware pattern set |
| NS | The normal pattern set |
| MBF | The Bloom filter that contains the malware pattern set |
| NBF | The Bloom filter that contains the normal pattern set |
| Hm | The hash function set of MBF, Hm = {h₁, h₂, . . . , hₕₘ} |
| Hn | The hash function set of NBF, Hn = {h₁, h₂, . . . , hₕₙ} |
| Hm(x) | The hash codes of pattern x in terms of Hm, i.e., |
| | h₁(x), h₂(x), . . . , hₕₘ(x) |
| Hn(x) | The hash codes of pattern x in terms of Hn, i.e., |
| | h₁(x), h₂(x), . . . , hₕₙ(x) |
| MBF[Hm(x)] | The mapping positions of pattern x in MBF, i.e., |
| | MBF[h₁(x)], MBF[h₂(x)], . . . , MBF[hₕₘ(x)] |
| NBF[Hm(x)] | The mapping positions of pattern x in NBF, i.e., |
| | NBF[h₁(x)], NBF[h₂(x)], . . . , NBF[hₕₙ(x)] |
| Mal Weight | The table that saves the weights of malware patterns |
| | by linking them to the positions of patterns in MBF. |
| | E.g., for pattern x, its weight MWₓ is indexed by |
| | MBF[h₁(x)], MBF[h₂(x)], . . . , MBF[hₕₘ(x)] |
| NorWeight | The table that saves the weights of normal patterns |
| | by linking them to the positions of patterns in NBF. E.g., |
| | for pattern y, its weight NW_{y} is indexed by |
| | NBF[h₁(x)], NBF[h₂(x)], . . . , NBF[hₕₙ(x)] |
| MW | The sum of matched malware pattern weights |
| NW | The sum of matched normal pattern weights |
| Tm | The threshold of malware detection |
| Tn | The threshold of normal app detection |

Algorithm 1: Countable BF Generation.
Input: K={k₁, k₂, . . . , kₙ} (i=1, . . . , n), element kᵢ with weight wᵢ going to be insert into BF, H of BF, V and its length l,
Initialization: Set the values of all positions in V as 0;
   For kᵢ (i=1, . . . , n) do
      Calculate h₁(kᵢ), h₂(kᵢ), . . . , hₕ(kᵢ);
      Get positions of h₁(kᵢ), h₂(kᵢ), . . . , hₕ(kᵢ) in BF, i.e., BF[h₁(kᵢ)],BF[h₂(kᵢ)], . . . ,BF[hₕ(kᵢ)], and add 1 to the values of corresponding positions;
   Set wᵢ in a table (either MalWeight or NorWeight) indexed by BF positions BF [h₁(kᵢ)], BF[h₂(kᵢ)], . . . , BF[hₕ(kᵢ)]
   End
Output: the BF after inserting K

When detecting an unknown app a, a dynamic method is used to collect its runtime patterns Pa (Pₐ={p_{a,1}, p_{a,2}, . . . , p_{a,na}}) (e.g., system calling data including both individual calls and sequential system calls with different depth). Then the mobile device uses Hire and Hn to calculate their hash codes Hm(pₐ)={Hm(p_{a,1}), Hm(p_{a,2}), . . . , Hm(p_{a,na})} and Hn(pₐ)={Hn(p_{a,1}), Hn(p_{a,2}), . . . , Hn(p_{a,na})} and sends them to the server for checking if some patterns match the patterns inside MBF and NBF.

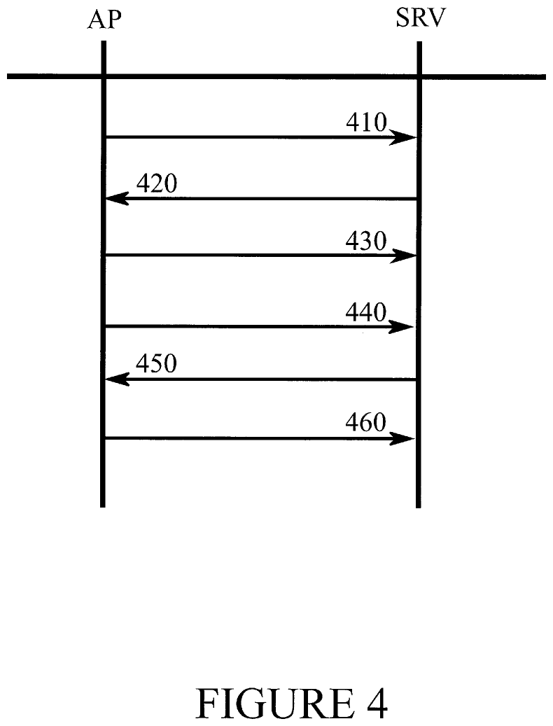

The server searches Hm(Pₐ) in the MBF. If all positions' values of Hm(p_{a,i}) in MBF is more than 0, sum the weight of this pattern saved in MalWeight. The server searches the hashes of all patterns in Hm(Pₐ) and get MWₐ. In addition, the server searches Hn(Pₐ) in NBF. If all positions' values of Hn(p_{a,i}) in NBF is more than 0, sum the weight of this pattern saved in NorWeight. The server searches the hashes of all patterns in Hn(Pₐ) and get NWₐ. Refer to Algorithm 2 about countable BF search. Next, the server compares MWₐ and NWₐ with Tm and Tn to decide if app a is normal or malicious. FIG. 4 shows the procedure of app detection.

Algorithm 2: Countable BF Search
Input: element k that is going to be searched in BF (MBF or NBF), H of BF, V and its length l, search result f (k) and w(k)
Calculate h₁(k), h₂(k), . . . , hₕ(k);
Get positions of h₁(k), h₂(k), . . . , hₕ(k) in BF, i.e., BF[h₁(k)], BF[h₂(k)], . . . , BF[hₕ(k)];
If there is one of the above positions' values is 0, k is not inside BF, set f (k)=0
Else if all above positions' values are above 0, k is inside BF, set f (k)=1
   Check the weight of k in corresponding weight table (MalWeight or NorWeight), set w(k) as the weight recorded in the table
Output: f (k) and w(k)

Algorithm 3: Countable BF Update
Input: element k with weight wₖ that is going to be updated in BF (MBF or NBF), H of BF, V and its length l
Calculate h₁(k), h₂(k), . . . , hₕ(k);
Get positions of h₁(k), h₂(k), . . . , hₕ(k) in BF, i.e., BF[h₁(k)], BF[h₂(k)], . . . , BF[hₕ(k)];
If there is one of the above positions' values is 0, k is not inside BF
   Insert k into BF by adding 1 to the values of corresponding positions;
   Set wₖ in a table (either MalWeight or NorWeight) indexed by BF positions BF[h₁(kᵢ)], BF[h₂(kᵢ)], . . . , BF[hₕ(kᵢ)]
Else if all above positions' values are above 0, k is inside BF
   Find the weight of k in corresponding weight table (MalWeight or NorWeight) indexed by BF positions BF[h₁(kᵢ)], BF[h₂(kᵢ)], . . . , BF[hₕ(kᵢ)], update this weight value as wₖ in the table
Output: the newly updated BF and weight table

Algorithm 4: Countable BF Delete
Input: element k that is going to be deleted in BF (MBF or NBF), H of BF, V and its length l
Calculate h₁(k), h₂ (k), . . . , hₙ (k);
Get positions of h₁(k), h₂(k), . . . , hₕ(k) in BF, i.e., BF[h₁(k)], BF[h₂(k)], . . . , BF[hₕ(k)];
If there is one of the above positions' values is 0, k is not inside BF, algorithm ends
Else if all above positions' values are above 0, k is inside BF
   Deduct 1 from the values of BF[h₁(k)], BF[h₂ (k)], . . . , BF[hₕ(k)];
   Find the weight of k in corresponding weight table (MalWeight or NorWeight), remove this weight item in the table
Output: the newly updated BF and weight table

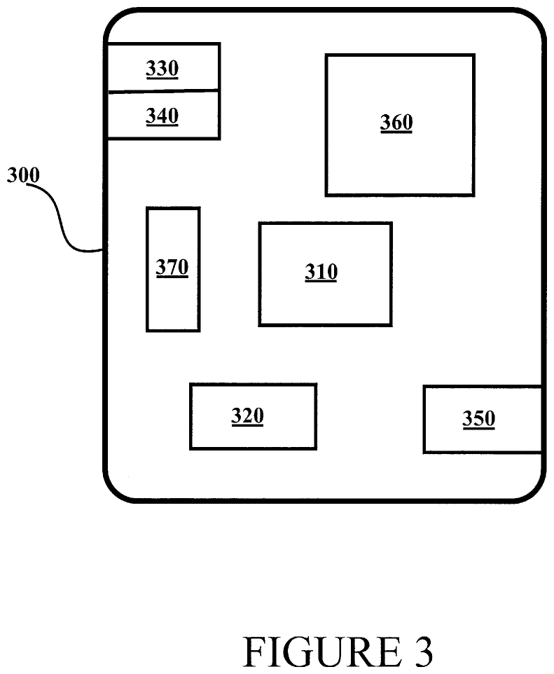

FIG. 3 illustrates an example apparatus capable of supporting at least some embodiments of the present invention. Illustrated is device 300, which may comprise, for example, a mobile communication device such as mobile 110 of FIG. 1 or a server device, for example, in applicable parts. Comprised in device 300 is processor 310, which may comprise, for example, a single- or multi-core processor wherein a single-core processor comprises one processing core and a multi-core processor comprises more than one processing core. Processor 310 may comprise, in general, a control device. Processor 310 may comprise more than one processor. Processor 310 may be a control device. A processing core may comprise, for example, a Cortex-A8 processing core manufactured by ARM Holdings or a Steamroller processing core produced by Advanced Micro Devices Corporation. Processor 310 may comprise at least one Qualcomm Snapdragon and/or Intel Atom processor. Processor 310 may comprise at least one application-specific integrated circuit, ASIC. Processor 310 may comprise at least one field-programmable gate array, FPGA. Processor 310 may be means for performing method steps in device 300. Processor 310 may be configured, at least in part by computer instructions, to perform actions.

A processor may comprise circuitry, or be constituted as circuitry or circuitries, the circuitry or circuitries being configured to perform phases of methods in accordance with embodiments described herein. As used in this application, the term “circuitry” may refer to one or more or all of the following: (a) hardware-only circuit implementations, such as implementations in only analog and/or digital circuitry, and (b) combinations of hardware circuits and software, such as, as applicable: (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Device 300 may comprise memory 320. Memory 320 may comprise random-access memory and/or permanent memory. Memory 320 may comprise at least one RAM chip. Memory 320 may comprise solid-state, magnetic, optical and/or holographic memory, for example. Memory 320 may be at least in part accessible to processor 310. Memory 320 may be at least in part comprised in processor 310. Memory 320 may be means for storing information. Memory 320 may comprise computer instructions that processor 310 is configured to execute. When computer instructions configured to cause processor 310 to perform certain actions are stored in memory 320, and device 300 overall is configured to run under the direction of processor 310 using computer instructions from memory 320, processor 310 and/or its at least one processing core may be considered to be configured to perform said certain actions. Memory 320 may be at least in part comprised in processor 310. Memory 320 may be at least in part external to device 300 but accessible to device 300.

Device 300 may comprise a transmitter 330. Device 300 may comprise a receiver 340. Transmitter 330 and receiver 340 may be configured to transmit and receive, respectively, information in accordance with at least one cellular or non-cellular standard. Transmitter 330 may comprise more than one transmitter. Receiver 340 may comprise more than one receiver. Transmitter 330 and/or receiver 340 may be configured to operate in accordance with global system for mobile communication, GSM, wideband code division multiple access, WCDMA, 5G, long term evolution, LTE, IS-95, wireless local area network, WLAN, Ethernet and/or worldwide interoperability for microwave access, WiMAX, standards, for example.

Device 300 may comprise a near-field communication, NFC, transceiver 350. NFC transceiver 350 may support at least one NFC technology, such as NFC, Bluetooth, Wibree or similar technologies.

Device 300 may comprise user interface, UI, 360. UI 360 may comprise at least one of a display, a keyboard, a touchscreen, a vibrator arranged to signal to a user by causing device 300 to vibrate, a speaker and a microphone. A user may be able to operate device 300 via UI 360, for example to configure malware detection functions.

Device 300 may comprise or be arranged to accept a user identity module 370. User identity module 370 may comprise, for example, a subscriber identity module, SIM, card installable in device 300. A user identity module 370 may comprise information identifying a subscription of a user of device 300. A user identity module 370 may comprise cryptographic information usable to verify the identity of a user of device 300 and/or to facilitate encryption of communicated information and billing of the user of device 300 for communication effected via device 300.

Processor 310 may be furnished with a transmitter arranged to output information from processor 310, via electrical leads internal to device 300, to other devices comprised in device 300. Such a transmitter may comprise a serial bus transmitter arranged to, for example, output information via at least one electrical lead to memory 320 for storage therein. Alternatively to a serial bus, the transmitter may comprise a parallel bus transmitter. Likewise processor 310 may comprise a receiver arranged to receive information in processor 310, via electrical leads internal to device 300, from other devices comprised in device 300. Such a receiver may comprise a serial bus receiver arranged to, for example, receive information via at least one electrical lead from receiver 340 for processing in processor 310. Alternatively to a serial bus, the receiver may comprise a parallel bus receiver.

Device 300 may comprise further devices not illustrated in FIG. 3. For example, where device 300 comprises a smartphone, it may comprise at least one digital camera. Some devices 300 may comprise a back-facing camera and a front-facing camera, wherein the back-facing camera may be intended for digital photography and the front-facing camera for video telephony. Device 300 may comprise a fingerprint sensor arranged to authenticate, at least in part, a user of device 300. In some embodiments, device 300 lacks at least one device described above. For example, some devices 300 may lack a NFC transceiver 350 and/or user identity module 370.

Processor 310, memory 320, transmitter 330, receiver 340, NFC transceiver 350, UI 360 and/or user identity module 370 may be interconnected by electrical leads internal to device 300 in a multitude of different ways. For example, each of the aforementioned devices may be separately connected to a master bus internal to device 300, to allow for the devices to exchange information. However, as the skilled person will appreciate, this is only one example and depending on the embodiment various ways of interconnecting at least two of the aforementioned devices may be selected without departing from the scope of the present invention.

FIG. 4 illustrates signalling in accordance with at least some embodiments of the present invention. On the vertical axes are disposed, on the left, authorized party AP, and on the right, server SRV. These entities correspond to those in FIGS. 1 and 2. Time advances from the top toward the bottom.

In phase 410, the AP needs to add or revise a specific hash output value pattern in the malware pattern set in the server. A pattern update request is sent to the server. The server responds by sharing the hash value set Hm to the AP in phase 420. Further, if necessary, the server re-initializes the malware Bloom filter MBF and sets up the MalWeight table. In phase 430, the AP provides to the server the hash output value pattern Hm(x) with weight MWₓ. The server inserts the hash output value pattern Hm(x) into filter MBF and updates the MalWeight table. If Hm(x) is already in MBF, the server may update its weight in MalWeight. Such updating may be an increase of the weight by MWₓ.

Phases 440-460 illustrate a similar process for non-malware. Phase 440 comprises a pattern update request concerning the non-malware patterns. Phase 450 comprises the server providing the hash function set Hn to the AP, and phase 460 comprises the AP providing the hash output value set Hn(y) to the server, along with weight NW_{y}. In phase 460, the server inserts the hash output value pattern Hn(y) into filter NBF and updates the NorWeight table. If Hn(y) is already in NBF, the server may update its weight in NorWeight. Such updating may be an increase of the weight by NW_{y}.

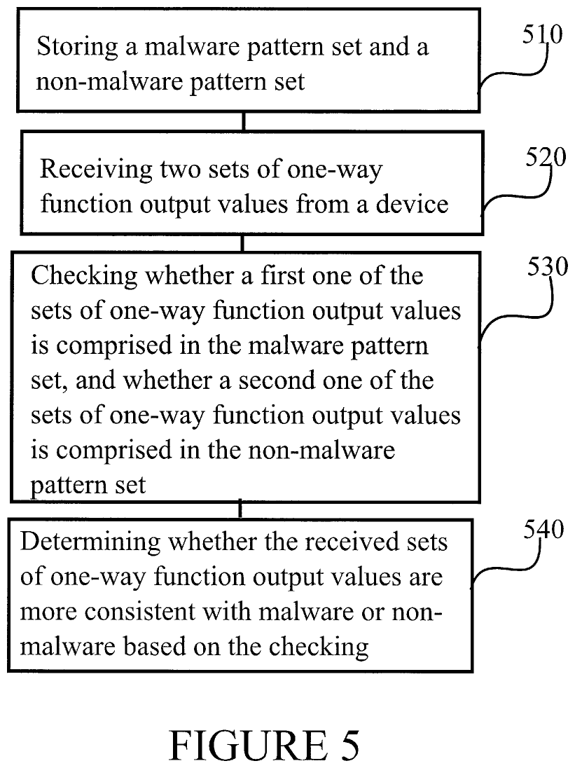

FIG. 5 is a flow graph of a method in accordance with at least some embodiments of the present invention. The phases of the illustrated method may be performed in the server, for example, or in a control device configured to control the functioning thereof, when installed therein.

Phase 510 comprises storing a malware pattern set and a non-malware pattern set. The pattern sets may comprise one-way function output values of behavioural data of malware and non-malware applications, respectively. Phase 520 comprises receiving two sets of one-way function output values from a device. Phase 530 comprises checking whether a first one of the two sets of one-way function output values is comprised in the malware pattern set, and whether a second one of the two sets of one-way function output values is comprised in the non-malware pattern set. Finally, phase 540 comprises determining whether the received sets of one-way function output values are more consistent with malware or non-malware based on the checking.

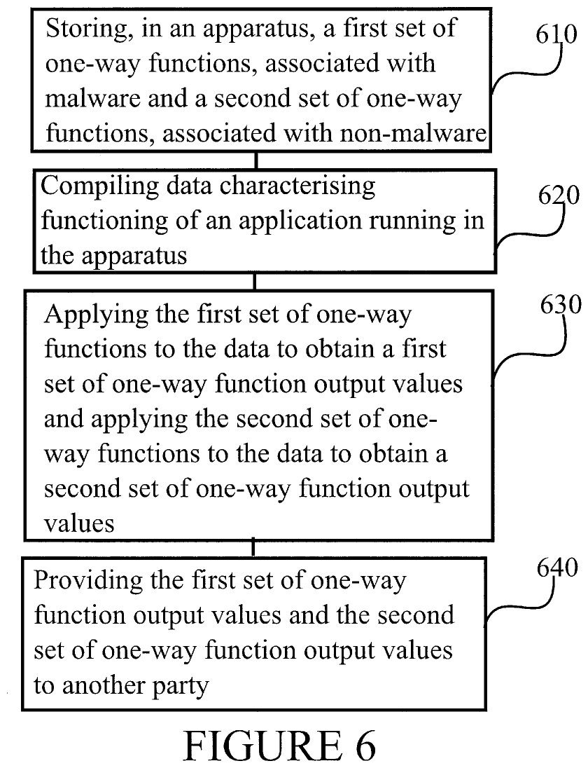

FIG. 6 is a flow graph of a method in accordance with at least some embodiments of the present invention. The phases of the illustrated method may be performed in the user device, for example, or in a control device configured to control the functioning thereof, when installed therein.

Phase 610 comprises storing, in an apparatus, a first set of one-way functions and a second set of one-way functions, the first set of one-way functions comprising a malware function set and the second set of one-way functions comprising a non-malware function set. Phase 620 comprises compiling data characterizing functioning of an application running in the apparatus. Phase 630 comprises applying the first set of one-way functions to the data to obtain a first set of one-way function output values and applying the second set of one-way functions to the data to obtain a second set of one-way function output values. Finally, phase 640 comprises providing the first set of one-way function output values and the second set of one-way function output values to a server.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the preceding description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

### INDUSTRIAL APPLICABILITY

At least some embodiments of the present invention find industrial application in malware detection and privacy protection.

REFERENCE SIGNS LIST

| | |
|---|---|
| 110, 115 | Mobile |
| 120 | Base station |
| 130 | Network node |
| 140 | Network |
| 150 | Server |
| 160 | Central trusted entity |
| 210-250 | Phases of FIG. 2 (AP) |
| 260-2110 | Phases of FIG. 2 (SRV) |
| 2120-2140 | Phases of FIG. 2 (DEVICE) |
| 300-370 | Structure of the device of FIG. 3 |
| 410-460 | Phases of signalling in FIG. 4 |
| 510-540 | Phases of the method of FIG. 5 |
| 610-640 | Phases of the method of FIG. 6 |

### CITATION LIST

[1] Zheng M, Sun M, Lui J. DroidTrace: A ptrace based Android dynamic analysis system with forward execution capability[C]//Wireless Communications and Mobile Computing Conference (IWCMC), 2014 International. IEEE, 2014: 128-133.
[2] Li Q, Li X. Android Malware Detection Based on Static Analysis of Characteristic Tree[C]//Cyber-Enabled Distributed Computing and Knowledge Discovery (CyberC), 2015 International Conference on. IEEE, 2015: 84-91
[3] Moghaddam S H, Abbaspour M. Sensitivity analysis of static features for Android malware detection[C]//Electrical Engineering (ICEE), 2014 22nd Iranian Conference on. IEEE, 2014: 920-924.
[4] Yerima S Y, Sezer S, McWilliams G. Analysis of Bayesian classification-based approaches for Android malware detection[J]. IET Information Security, 2014, 8(1): 25-36.
[5] Bläsing T, Batyuk L, Schmidt A D, et al. An android application sandbox system for suspicious software detection[C]//Malicious and unwanted software (MALWARE), 2010 5th international conference on. IEEE, 2010: 55-62.
[6] Wu D J, Mao C H, Wei T E, et al. Droidmat: Android malware detection through manifest and api calls tracing[C]//Information Security (Asia JCIS), 2012 Seventh Asia Joint Conference on. IEEE, 2012: 62-69.
[7] Li J, Zhai L, Zhang X, et al. Research of android malware detection based on network traffic monitoring[C]//Industrial Electronics and Applications (ICIEA), 2014 IEEE 9th Conference on. IEEE, 2014: 1739-1744.
[8] Egele M, et al. (2012) A survey on automated dynamic malware analysis techniques and tools. ACM Computing Surveys. https://www.seclab.tuwien.ac.at/papers/malware_survey.pdf.
[9] P. Yan, Z. Yan*, “A Survey on Dynamic Mobile Malware Detection”, Software Quality Journal, pp. 1-29, May 2017. Doi: 10.1007/s11219-017-9368-4
[10] S. Das, Y. Liu, W. Zhang, M. Chandramohan, Semantics-based online malware detection: towards efficient real-time protection against malware, IEEE Trans. Information Forensics and Security, 11(2), pp. 289-302, 2016.
[11] Tong, Z. Yan*, “A Hybrid Approach of Mobile Malware Detection in Android”, Journal of Parallel and Distributed Computing, Vol. 103, pp. 22-31, May 2017.
[12] W. Enck, “TaintDroid: An Information-Flow Tracking System for Real-Time Privacy Monitoring on Smartphones,” Proc. 9th Usenix Symp. Operating Systems Design and Implementation (OSDI 10), Usenix, 2010; http://static.usenix.org/events/osdi10/tech/full_papers/Enck.pdf.
[13] T. Biasing et al., “An Android Application Sandbox System for Suspicious Software Detection,” Proc. 5th Int'l Conf.Malicious and Unwanted Software (Malware 10), ACM, 2010, pp. 55-62.
[14] Zheng Yan, Fei Tong, A Hybrid Approach of Malware Detection, Patent Application No. PCT/CN2016/077374, Filed Date 25 Mar. 2016.
[15] Burton H. Bloom. Space time trade-offs in hash coding with allowable errors. Communications of the ACM, 1970, 13(7):422-426.

1-35. (canceled)

36. An apparatus comprising at least one processor, at least one memory including computer program code, the at least one memory and the computer program code configured to, with the at least one processor, cause the apparatus at least to perform:
receive two sets of one-way function output values from a device;
check whether a first one of the two sets of the one-way function output values is comprised in a malware pattern set, and whether a second one of the two sets of the one-way function output values is comprised in a non-malware pattern set, and
determine whether the received two sets of the one-way function output values are more consistent with malware or non-malware based on the checking.

37. The apparatus according to claim 36, wherein the apparatus is configured to store the malware pattern set in a first Bloom filter and the non-malware pattern set in a second Bloom filter, and wherein the apparatus is configured to check whether the first one of the two sets of the one-way function output values is comprised in the malware pattern set by running the first Bloom filter and wherein the apparatus is configured to check whether the second one of the two sets of the one-way function output values is comprised in the non-malware pattern set by running the second Bloom filter.

38. The apparatus according to claim 36, wherein the malware pattern set is a set of vectors comprising one-way function output values associated with malware and wherein the non-malware pattern set is a set of vectors comprising one-way function output values associated with non-malware.

39. The apparatus according to claim 36, wherein the two sets of the one-way function output values are two sets of hash values.

40. The apparatus according to claim 37, wherein running the first one of the two sets of the one-way function output values with the first Bloom filter comprises applying a malware weight vector to the first Bloom filter, and wherein running the second one of the two sets of one-way function output values with the second Bloom filter comprises applying a non-malware weight vector to the second Bloom filter.

41. The apparatus according to claim 36, wherein the apparatus is configured to inform the device of the determination whether the received sets of one-way function output values are more consistent with malware or non-malware.

42. The apparatus according to claim 41, wherein the apparatus is configured to advise the device, what to do with an application associated with the two sets of the one-way function output values.

43. The apparatus according to claim 37, wherein the apparatus is configured to define the first Bloom filter and the second Bloom filter based on information received in the apparatus from a central trusted entity.

44. An apparatus comprising at least one processor, at least one memory including computer program code, the at least one memory and the computer program code configured to, with the at least one processor, cause the apparatus at least to perform:
store a first set of one-way functions and a second set of one-way functions, the first set of the one-way functions comprising a malware function set and the second set of the one-way functions comprising a non-malware function set;
compile data characterizing functioning of an application running in the apparatus;
apply the first set of the one-way functions to the data to obtain a first set of one-way function output values and apply the second set of the one-way functions to the data to obtain a second set of one-way function output values, and
provide the first set of the one-way function output values and the second set of the one-way function output values to another party.

45. The apparatus according to claim 44, wherein the one-way functions are at least one of modular functions or hash functions.

46. The apparatus according to claim 44, wherein the data comprises at least one runtime pattern of the application.

47. The apparatus according to claim 46, wherein the at least one runtime pattern of the application comprises at least one pattern of system calls made by the application.

48. The apparatus according to claim 47, wherein the at least one pattern of the system calls comprises at least one of: pattern of sequential system calls with differing calling depth that are related to file access, a pattern of sequential system calls with differing calling depth that are related to network access or a pattern of sequential system calls with differing calling depth that are related to other operations than network access and file access.

49. The apparatus according to claim 44, further configured to delete or quarantine the application based on an indication received from the server in response to the sets of the one-way function output values.

50. The apparatus according to claim 44, wherein the apparatus is a mobile device.

51. A method comprising:
receiving two sets of one-way function output values from a device;
checking whether a first one of the two sets of the one-way function output values is comprised in a malware pattern set, and whether a second one of the two sets of the one-way function output values is comprised in a non-malware pattern set, and
determining whether the received two sets of one-way function output values are more consistent with malware or non-malware based on the checking.

52. The method according to claim 51, further comprising storing the malware pattern set in a first Bloom filter and the non-malware pattern set in a second Bloom filter, and checking whether the first one of the two sets of the one-way function output values is comprised in the malware pattern set by running the first Bloom filter and checking whether the second one of the two sets of the one-way function output values is comprised in the non-malware pattern set by running the second Bloom filter.

53. The method according to claim 51, wherein the malware pattern set is a set of vectors comprising one-way function output values associated with malware and wherein the non-malware pattern set is a set of vectors comprising one-way function output values associated with non-malware.

54. The method according to claim 51, wherein the two sets of one-way function output values are two sets of hash values.

55. The method according to claim 52, wherein running the first one of the two sets of the one-way function output values with the first Bloom filter comprises applying a malware weight vector to the first Bloom filter, and wherein running the second one of the two sets of the one-way function output values with the second Bloom filter comprises applying a non-malware weight vector to the second Bloom filter.
